(19) United States
(12) Patent Application Publication
(10) Pub. No.: US 2020/0021450 A1
(43) Pub. Date: Jan. 16, 2020

(54) MANAGING MULTICAST SCALING

(71) Applicant: Hewlett Packard Enterprise Development LP, Houston, TX (US)

(72) Inventors: Tathagata Nandy, Bangalore Karnataka (IN); Balaji Sankaran, Bangalore Karnataka (IN); Tinoj Joseph, Bangalore Karnataka (IN)

(21) Appl. No.: 16/031,256

(22) Filed: Jul. 10, 2018

(51) Int. Cl. H04L 12/18; H04L 12/46

(52) U.S. Cl. CPC H04L 12/18; H04L 12/4641

(57) ABSTRACT

Some examples relate to managing multicast scaling. In an example, a determination may be made at a network device whether more than a pre-defined percentage of ports of a virtual LAN (VLAN) are associated with an IP multicast group. In response to the determination that more than a pre-defined percentage of ports on the VLAN are associated with the IP multicast group, a flood filter may be programmed on the network device for the VLAN. A hardware filter previously associated with the IP multicast group may be disassociated.

### BACKGROUND

Multicast technology is being increasingly favored to provide rich content over a network. Multicast is a mechanism for transmitting data from a single source (for example, a server) to multiple receivers (for example, personal computers) on a network. Multicast packets are replicated down appropriate paths in a network to create the most efficient routing mechanism possible. The sender may send a data packet once, even if the packet is to be delivered to multiple receivers.

### BRIEF DESCRIPTION OF THE DRAWINGS

The following detailed description references the drawings, wherein:

FIG. 1 is a block diagram of an example computing environment for managing multicast scaling;

FIG. 2 is a block diagram of an example network device for managing multicast scaling;

FIG. 3 is a flowchart of an example method for managing multicast scaling;

FIG. 4 is a block diagram of an example method for managing multicast scaling; and

FIG. 5 is a block diagram of an example system including instructions in a machine-readable storage medium to manage multicast scaling.

### DETAILED DESCRIPTION

Multicast technology may be used by organizations to send data (especially, multimedia content) over a network. Multicast technology may allow host computer systems, who have subscribed to a particular content data flow of a content server, to receive the content. Host systems may signify their willingness to receive a particular data from a content server by joining a particular multicast group. Once host systems join a particular group, a multicast distribution tree may be created for that group. The flow of data from a multicast source system to receiver devices may be managed by a multicast protocol. Some non-limiting examples of protocols that may be used to manage flow of data in a multicast system may include Internet Group Management Protocol (IGMP), Multicast Listener Discovery (MLD) protocol, Protocol Independent Multicast (PIM), and Distance Vector Multicast Routing Protocol (DVMRP).

IP multicast may allow content providers to offer high quality service to customers while efficiently utilizing network bandwidth. However, a multicast deployment may face scaling challenges. The number of new devices that are getting included in an enterprise network are increasing every day. For example, Bring Your Own Device (BYOD) concept or Internet of Things (IoT) devices are putting additional constraints on the existing multicast resources. In an example deployment of an IP multicast protocol in a LAN, the protocol application may maintain the multicast group information and program the hardware filters on network devices to define the multicast data traffic behavior. Hardware filters may be provided as a port map where the intended ports to receive the multicast traffic are programmed. The number of hardware filters in a network device may be limited by the ASIC type. However, there's no limit on the number of multicast groups (for example, standard or static multicast groups) that may be added to a network device (e.g., a network switch). As per current behavior, whenever an IGMP/MLD join is received for a new group, a new hardware filter is allocated. As every individual group consumes a filter, the number of joins that are supported is limited by the number of filters available in a network device. A large number of IGMP join messages may lead to hardware filter exhaustion and device failure in the event of a crash. This is not a desirable scenario.

To address this issue, the present disclosure describes various examples for managing multicast scaling. In an example, a determination may be made at a network device (e.g., a network switch) whether more than a pre-defined percentage of ports of a virtual LAN (VLAN) are associated with an IP multicast group. In response to the determination that more than a pre-defined percentage of ports on the VLAN are associated with the IP multicast group, a flood filter may be programmed on the network device for the VLAN. And, a hardware filter previously associated with the IP multicast group may be disassociated. The proposed solution provides a mechanism for optimizing hardware filters in a network device.

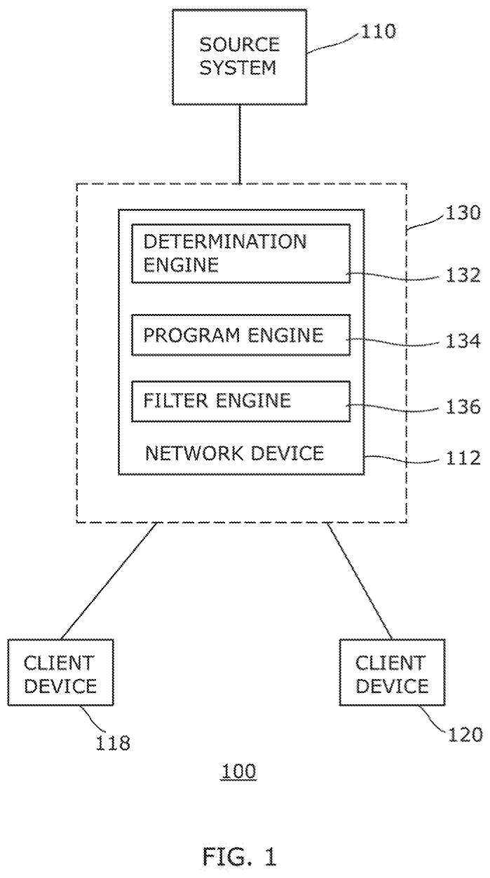

FIG. 1 is a block diagram of an example computing environment 100 for managing multicast scaling. In an example, computing environment 100 may include a source system 110, a network device 112, and client devices 118 and 120. Although one source system, one network device, and two client computing devices are shown in FIG. 1, other examples of this disclosure may include more than one source system, more than one network device, and more or less than two client computing devices.

Source system 110, network device 112, and client computing devices 118 and 120, may be communicatively coupled, for example, via a computer network 130. Such a computer network 130 may be a wireless or wired network. Such a computer network 130 may include, for example, a Local Area Network (LAN), a Wireless Local Area Network (WAN), a Metropolitan Area Network (MAN), a Storage Area Network (SAN), a Campus Area Network (CAN), or the like. Further, such a computer network 130 may be a public network (for example, the Internet) or a private network (for example, an intranet). In an example, computer network 130 may be an IPv4 or IPv6 network. In an example, computer network 130 may be used to transmit and route multicast content.

Source system 110 may be any type of computing device capable of reading machine-executable instructions. Examples of the computing device may include, without limitation, a server, a desktop computer, a notebook computer, a tablet computer, a thin client, a mobile device, a personal digital assistant (PDA), a phablet, and the like. In an example, source system 110 may host multicast content. Multicast content may include, for example, data, image, audio, video, multimedia, and other like content. Multicast content may be shared with host computer systems (also known as multicast subscribers) through network device 112.

Network device 112 may include, for example, a router, a virtual router, a network switch, and a virtual switch. In an example, network device 112 may be a multicast router. Network device 112 may be used to route multicast data from source system 110 to a client computing device(s) (for example, 118 and 120).

In an example, network device 112 may include a plurality of hardware filters. The number of hardware filters in a network device may be limited by the ASIC type. In an example deployment of an IP multicast protocol in a LAN, the protocol application may maintain the multicast group information and program the hardware filters on network device 112 to define the multicast data traffic behavior. The number of hardware filters available on a network device (for example, 112) to process IP multicast messages (for example, a join message) may depend on the type of network device. In an example, up to 2048 hardware filters may be available on network device 112 for processing IP multicast messages of an IP multicast protocol (for example, IGMP and MLD). If multiple VLANs are configured, each filter may be counted once per VLAN in which it is used. Hardware filters may be provided as a port map where the intended ports to receive the multicast traffic are programmed. Network device 112 may support a plurality of VLANs.

Client computing devices 118 and 120 may each be any type of computing device that is capable of executing machine-readable instructions. Examples of the computing device may include, without limitation, a server, a desktop computer, a notebook computer, a tablet computer, a thin client, a mobile device, a personal digital assistant (PDA), a phablet, and the like. Client computing devices 118 and 120 may each include a client or multicast application for receiving multicast data from a source system (for example, 110).

Multicast technology may allow client computing devices (for example, 118 and 120), who may have subscribed to a particular content data flow of a source system (for example, 110), to receive content from the source system. Client devices (for example, 118 and 120) may signify their willingness to receive a particular data from a content server by joining a particular multicast group. Once client devices join a particular group, a multicast distribution tree may be created for that group. The flow of data from a multicast source system to receiver devices over network 130 may be managed by a multicast protocol. Examples of multicast protocol may include Internet Group Management Protocol (IGMP) and Multicast Listener Discovery (MLD) protocol.

IGMP and MLD may be used between client computing devices (for example, 118 and 120) and a multicast router (for example, 112) to request data for a given multicast group. Routers may use IGMP or MLD to build their multicast routing table.

The Internet Group Management Protocol (IGMP) is an Internet protocol that may be used by IPv4 systems (hosts and routers) to report their IP multicast group memberships to any neighboring multicast routers. The protocol may be used between end systems (hosts) and a multicast router to request data for a given multicast group.

Multicast Listener Discovery (MLD) protocol is a component of the Internet Protocol Version 6 (IPv6) suite. MLD may be used by IPv6 routers for discovering multicast listeners on a directly attached link, much like IGMP is used in IPv4.

Protocol Independent Multicast (PIM) is a family of multicast routing protocols for Internet Protocol (IP) networks that provide one-to-many and many-to-many distribution of data over a network. PIM is not dependent on a specific unicast routing protocol. PIM can make use of any unicast routing protocol in use on the network.

In an example, network device 112 may include a determination engine 132, a program engine 134, and a filter engine 136.

Engines 132, 134, and 136 may each include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of network device 112. In some examples, the at least one machine-readable storage medium may store instructions that, when executed by the at least one processing resource, at least partially implement some or all engines of network device 112. In such examples, network device 112 may include the at least one machine-readable storage medium storing the instructions and the at least one processing resource to execute the instructions.

In an example, determination engine 132 on network device 112 may determine whether more than a pre-defined percentage of ports of a virtual LAN (VLAN) are associated with an IP multicast group. VLAN technology may allow an enterprise to extend the reach of their corporate networks across a Wide Area Network (WAN). VLANs may enable a LAN to be partitioned based on functional requirements while maintaining connectivity across all devices on a network. VLAN groups network devices and enables them to behave as if they are in one single network.

In an example, determination engine 132 may carry out the determination by first identifying ports of a VLAN. Determination engine 132 may identify which of the VLAN ports are associated with an IP multicast group. Determination engine 132 may then identify the total number of VLAN ports associated with the IP multicast group, and use the identified number to determine the percentage of VLAN ports that are associated with an IP multicast group. Determination engine 132 may compare the determined percentage with a pre-defined percentage to determine whether the number of VLAN ports associated with an IP multicast group is more than the pre-defined percentage.

In an example, determination engine 132 may identify a VLAN port associated with an IP multicast group by determining whether the port has received an IGMP join message. When an IGMP client connected to a switch port wants to receive multicast traffic from a specific group, it may join the group by sending an IGMP join message to the network. In another example, determination engine 132 may identify a VLAN port associated with an IP multicast group by determining whether the port has received a MLD protocol join message. Hosts may join multicast groups by sending MLD report messages (join messages). In a further example, determination engine 132 may identify a VLAN port associated with an IP multicast group by detecting an IGMP querier on the port. If there is no multicast router in a VLAN to originate the queries, an IGMP snooping querier may be configured to send membership queries. An IGMP snooping querier may send out periodic IGMP queries that trigger IGMP report messages from hosts that want to receive IP multicast traffic. In a still further example, determination engine 132 may identify a VLAN port associated with an IP multicast group by detecting a PIM router on the port.

In response to a determination that more than a pre-defined percentage of ports on the VLAN are associated with the IP multicast group, program engine 134 may program a flood filter on network device for the VLAN. As used herein, a flood filter may refer to a global filter with all ports set. The flood filter may flood a received IP multicast packet to each port of network device 112 except the port it came in from.

In an example, determination engine 132 may determine whether more than a pre-defined percentage of ports of a VLAN are associated with an IP multicast group by comparing a port map of the VLAN with a port map of the hardware filter previously associated with the IP multicast group. If the port map of the VLAN and the port map of the hardware filter previously associated with the IP multicast group are same, program engine 134 may program a flood filter on network device for the VLAN. As used herein, a port map may include a list of outbound ports for forwarding data (for example, IP multicast data). In another example, if a new IGMP join message is received on a new port, or if a port is moved out of a VLAN, program engine 134 may program a flood filter on network device for the VLAN, if more than a pre-defined percentage of ports of a VLAN are associated with an IP multicast group.

After a flood filter has been associated with the VLAN, filter engine 136 may disassociate a previously associated hardware filter from the IP multicast group. Thus, a hardware filter that was earlier associated with the IP multicast group may be disassociated from the IP multicast group by filter engine. The previously associated hardware filter may include a hardware filter on network device that is reserved for managing data traffic related to the IP multicast group. The data traffic may relate to an IP multicast protocol. Disassociating the hardware filter may enable the released hardware filter to be used for another task, for example, for another IP multicast group.

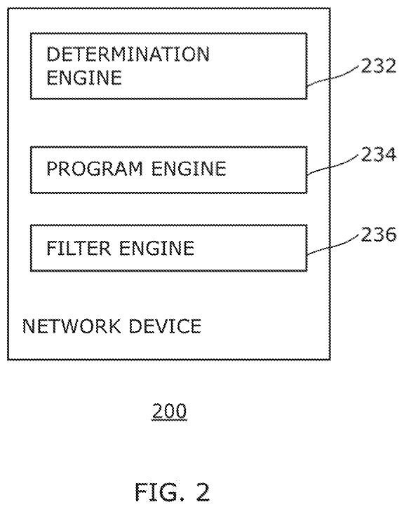

FIG. 2 is a block diagram of an example network device 200 for managing multicast scaling. In an example, network device 200 may be analogous to network device 112 FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. The components or reference numerals may be considered alike.

Network device 200 may be, for example, a router, a virtual router, a network switch, and a virtual switch. In an example, network device 200 may be a multicast router. Network device 200 may be used to route multicast data from a source system to client computing device (i.e. multicast receivers).

In an example, network device 200 may include a determination engine 232, a program engine 234, and a filter engine 236. In an example, determination engine 232, program engine 234, and filter engine 236 may perform functionalities similar to those described earlier in reference to determination engine 132, program engine 134, and filter engine 136 of FIG. 1, respectively.

In an example, determination engine 232 may determine whether more than a pre-defined percentage of ports of a virtual LAN (VLAN) are associated with an IP multicast group. In response to a determination that more than the pre-defined percentage of ports on the VLAN are associated with the IP multicast group, program engine 234 may program a flood filter for the VLAN. Filter engine 236 may then disassociate a previously associated hardware filter from the IP multicast group.

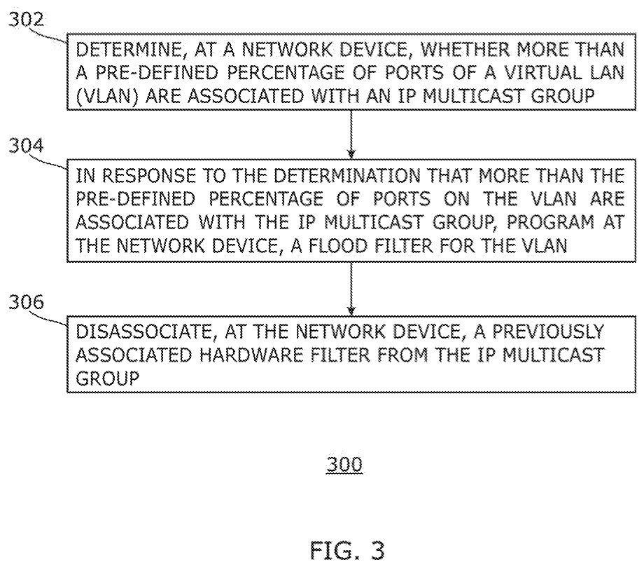

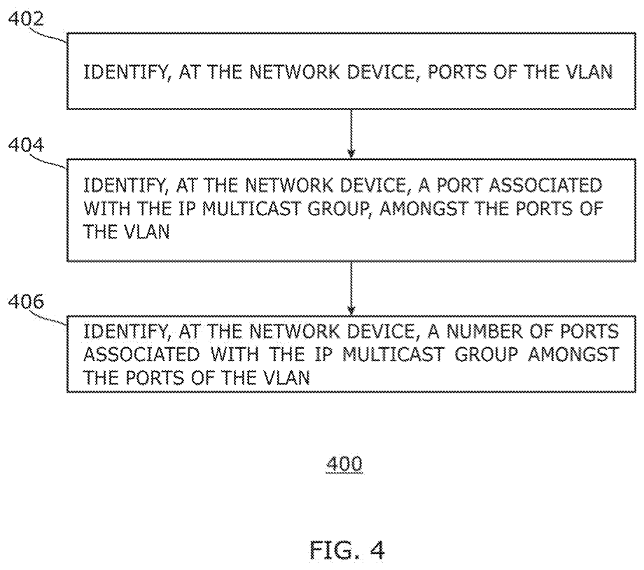

FIG. 3 is a flowchart of an example method 300 for managing multicast scaling. The method 300, which is described below, may at least partially be executed on a network device, for example, network device 112 of FIG. 1 or network device 200 of FIG. 2. However, other computing devices may be used as well. At block 302, a determination may be made at a network device (e.g., 112) whether more than a pre-defined percentage of ports of a virtual LAN (VLAN) are associated with an IP multicast group. FIG. 4 illustrates a flowchart of an example method 400 for determining whether more than a pre-defined percentage of ports of a virtual LAN (VLAN) are associated with an IP multicast group. At block 402, ports of the VLAN may be identified. At block 404, a VLAN port that is associated with an IP multicast group may be identified. At block 406, total number of VLAN ports that are associated with the IP multicast group may be identified, and the identified number may be used to determine the percentage of VLAN ports that are associated with an IP multicast group. The determined percentage may compared with a pre-defined percentage to determine whether the number of VLAN ports associated with an IP multicast group is more than the pre-defined percentage.

At block 304, in response to the determination that more than a pre-defined percentage of ports on the VLAN are associated with the IP multicast group, a flood filter may be programmed on the network device for the VLAN. At block 304, a hardware filter previously associated with the IP multicast group may be disassociated.

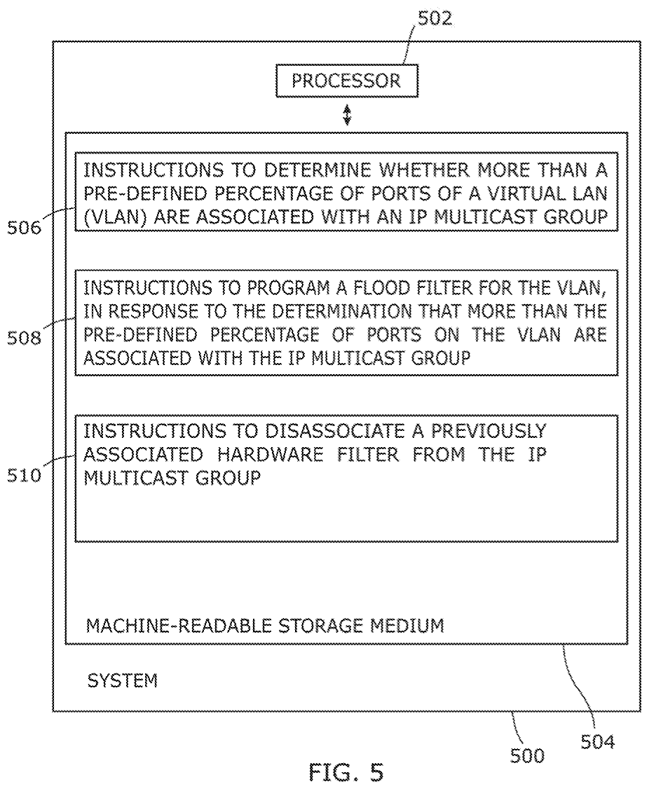

FIG. 5 is a block diagram of an example system 500 for managing multicast scaling. System 500 includes a processor 502 and a machine-readable storage medium 504 communicatively coupled through a system bus. In an example, system 500 may be analogous to network device 112 of FIG. 1 or network device 200 of FIG. 2. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 504 may be a non-transitory machine-readable medium. Machine-readable storage medium 504 may store instructions 506, 508, and 510. In an example, instructions 506 may be executed by processor 502 to determine whether more than a pre-defined percentage of ports of a virtual LAN (VLAN) are associated with an IP multicast group. Instructions 508 may be executed by processor 502 to program a flood filter for the VLAN, in response to the determination that more than the pre-defined percentage of ports on the VLAN are associated with the IP multicast group. Instructions 510 may be executed by processor 502 to disassociate a previously associated hardware filter from the IP multicast group.

For the purpose of simplicity of explanation, the example methods of FIGS. 3 and 4 are shown as executing serially, however it is to be understood and appreciated that the present and other examples are not limited by the illustrated order. The example systems of FIGS. 1, 2, and 5, and methods of FIGS. 3 and 4 may be implemented in the form of a computer program product including computer-executable instructions, such as program code, which may be run on any suitable computing device in conjunction with a suitable operating system (for example, Microsoft Windows®, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution. All of the features disclosed in this specification (including any accompanying claims, abstract and drawings), and/or all of the parts of any method or process so disclosed, may be combined in any combination, except combinations where at least some of such features and/or parts are mutually exclusive.

1. A method comprising:
determining, at a network device, whether more than a pre-defined percentage of ports of a virtual LAN (VLAN) are associated with an IP multicast group;
in response to the determination that more than the pre-defined percentage of ports on the VLAN are associated with the IP multicast group, programming, at the network device, a flood filter for the VLAN; and
disassociating, at the network device, a previously associated hardware filter from the IP multicast group.

2. The method of claim 1, further comprising:
using the previously associated hardware filter for a different IP multicast group.

3. The method of claim 1, wherein the flood filter is a global filter with all ports set.

4. The method of claim 1, wherein determining comprises:
identifying, at the network device, ports of the VLAN;
identifying, at the network device, a port associated with the IP multicast group, amongst the ports of the VLAN; and
identifying, at the network device, a number of ports associated with the IP multicast group amongst the ports of the VLAN.

5. The method of claim 1, wherein identifying the port associated with the IP multicast group comprises determining whether the port has received an IGMP join message.

6. The method of claim 1, wherein identifying the port associated with the IP multicast group comprises determining whether the port has received a MLD protocol join message.

7. The method of claim 1, wherein identifying the port associated with the IP multicast group comprises detecting an IGMP querier on the port.

8. The method of claim 1, wherein identifying the port associated with the IP multicast group comprises detecting a PIM router on the port.

9. A network device comprising:
a determination engine to determine whether more than a pre-defined percentage of ports of a virtual LAN (VLAN) are associated with an IP multicast group;
a program engine to, in response to the determination that more than the pre-defined percentage of ports on the VLAN are associated with the IP multicast group, program a flood filter for the VLAN; and
a filter engine to disassociate a previously associated hardware filter from the IP multicast group.

10. The network device of claim 9, wherein the flood filter is a global filter with all ports set.

11. The network device of claim 9, wherein the global flood filter to flood a received IP multicast packet to each port of the network device except a port it came in from.

12. The network device of claim 9, wherein the flood filter is unique to the VLAN.

13. The network device of claim 9, wherein the network device includes a plurality of hardware filters.

14. The network device of claim 9, wherein the network device is a network switch.

15. A non-transitory machine-readable storage medium comprising instructions, the instructions executable by a processor to:
determine whether more than a pre-defined percentage of ports of a virtual LAN (VLAN) are associated with an IP multicast group;
program a flood filter for the VLAN, in response to the determination that more than the pre-defined percentage of ports on the VLAN are associated with the IP multicast group; and
disassociate a previously associated hardware filter from the IP multicast group.

16. The storage medium of claim 15, wherein the previously associated hardware filter is a hardware filter reserved for managing data traffic related to the IP multicast group.

17. The storage medium of claim 15, wherein the data traffic relates to an IP multicast protocol.

18. The storage medium of claim 17, wherein the IP multicast protocol includes Internet Group Management Protocol (IGMP).

19. The storage medium of claim 17, wherein the IP multicast protocol includes Multicast Listener Discovery (MLD) protocol.

20. The storage medium of claim 15, wherein the instructions to determine include instructions to compare a port map of the VLAN with a port map of the previously associated hardware filter.
